(19) United States
(12) Patent Application Publication
(10) Pub. No.: US 2021/0190252 A1
(43) Pub. Date: Jun. 24, 2021

(54) TWO-WHEELED PIPE CRAWLER

(71) Applicant: GAS TECHNOLOGY INSTITUTE, Des Plaines, IL (US)

(72) Inventors: James Louis, Chicago, IL (US); Travis Cottle, Glenview, IL (US); Ryan L. Feist, Villa Park, IL (US)

(73) Assignee: GAS TECHNOLOGY INSTITUTE, Des Plaines, IL (US)

(21) Appl. No.: 17/099,344

(22) Filed: Nov. 16, 2020

Related U.S. Application Data
(60) Provisional application No. 62/949,955, filed on Dec. 18, 2019.

(51) Int. Cl. F16L 55/32; F16L 55/162; F16L 55/40

(52) U.S. Cl. CPC F16L 55/32; F16L 2101/30; F16L 55/40; F16L 55/162

(57) ABSTRACT

An untethered crawler for use within a pipeline, the crawler includes a body and a pair of wheels that are positionable between a retracted and a deployed position. A multi-axis control unit controls a roll, pitch, and yaw of the crawler within the pipeline.

### CROSS-REFERENCE TO RELATED APPLICATION

This application claims the benefit of U.S. Provisional Patent Application Ser. No. 62/949,955, filed on 18 Dec. 2019. The co-pending Provisional Patent Application is hereby incorporated by reference herein in its entirety and is made a part hereof, including but not limited to those portions which specifically appear hereinafter.

### BACKGROUND OF THE INVENTION

### Field of the Invention

The invention is related to an untethered self-powered two-wheeled pipe crawler.

### Background

Internal inspection, maintenance and repair of underground pipelines typically involves expensive excavation of the ground surrounding the pipeline. Excavation is at once expensive, time consuming and risks additional damage to the pipeline.

Alternatively, internal pipeline inspection tools are available that may be dropped into a pipeline, typically with a tether or similar leash. Such internal inspection tools, sometimes referred to as “pigs,” are typically cumbersome, expensive and have limited mobility within most pipelines.

Tools for internal pipeline inspection include those for geometric surveys of pipeline infrastructure and layout; detection of cracks or leaks; location of blockages or debris within the pipeline; and/or other functions particularly suited to the mapping, imaging and/or repair of a pipeline system.

Some previous untethered crawlers include Louis, U.S. Pat. No. 7,343,863 directed to a self-righting, bi-directional pipe crawler; Louis, U.S. Pat. No. 8,205,559 directed to a self-righting, two-wheeled pipe crawler; and Louis, U.S. Pat. No. 8,464,642 directed to a self-orienting, two-wheeled pipe crawler, which are each incorporated by reference herein.

### SUMMARY OF THE INVENTION

A preferred embodiment of the invention describes an untethered crawler for use within a pipeline. The crawler preferably comprises a body; a pair of wheels that are positionable between a retracted and a deployed position; and a multi-axis control unit for controlling axial motion, yaw, pitch and roll of the crawler within the pipeline. Such a device may be better understood with the following drawings and detailed description of preferred embodiments.

### BRIEF DESCRIPTION OF THE DRAWINGS

FIG. 1A shows roll as traditionally used in aviation;

FIG. 1B shows pitch as traditionally used in aviation;

FIG. 1C shows yaw as traditionally used in aviation;

FIG. 2A shows a crawler in a retracted position, according to one embodiment;

FIG. 2B shows the crawler of FIG. 2A transitioning from the retracted position to a deployed position, according to one embodiment;

FIG. 2C shows the crawler of FIG. 2B transitioned to the deployed position, according to one embodiment;

FIG. 3 shows an exploded front perspective view of a crawler according to one embodiment;

FIG. 4 shows an exploded front view of the crawler shown in FIG. 3;

FIG. 5 shows a front perspective view of a crawler with wheels in a retracted position, according to one embodiment;

FIG. 6 shows a front view of the crawler shown in FIG. 5;

FIG. 7 shows a front perspective view of a crawler with wheels in a deployed position, according to one embodiment;

FIG. 8 shows a front view of the crawler shown in FIG. 7;

FIG. 9 shows a front perspective view of the crawler shown in FIG. 5 with wheels exhibiting roll control, according to one embodiment;

FIG. 10 shows a top view of the crawler shown in FIG. 9 including measurements for calculating a deployment axis;

FIG. 11 shows calculations in accordance with FIG. 10;

FIG. 12A shows a deployment sequence starting with orientation of the crawler;

FIG. 12B shows a deployment sequence starting from a position of the crawler shown in FIG. 12A where the wheels are starting deployment;

FIG. 12C shows a deployment sequence from FIG. 12A where the wheels are driven while unfolding;

FIG. 12D shows a deployment sequence from FIG. 12A where the wheels are fully deployed at the calculated angle of the elliptical plane calculated in FIGS. 10 and 11;

FIG. 13A shows a front schematic view of a crawler beginning a roll sequence according to one embodiment;

FIG. 13B shows a front schematic view of the crawler of FIG. 13A with angled wheels relative to one another to initiate the roll sequence;

FIG. 13C shows a front schematic view of the crawler of FIG. 13A with compensated angled wheels relative to one another to continue the roll sequence;

FIG. 14 shows a cutaway view inside a pipeline with the crawler in a roll;

FIG. 15 shows a partially exploded perspective view of a crawler with a flywheel according to one embodiment;

FIG. 16A shows a cutaway view inside a pipeline with a crawler in a configuration prior to turning a corner;

FIG. 16B shows the pipeline of FIG. 16A after the crawler turns the corner;

FIG. 17 shows a perspective view of a crawler with sensors and measurable variables according to one embodiment;

FIG. 18 shows a cutaway view inside a pipeline with a crawler demonstrating axial translation, according to one embodiment;

FIG. 19 shows a cutaway view inside a pipeline with a crawler demonstrating yaw control, according to one embodiment;

FIG. 20 shows a schematic view of a pipeline and hot tap, according to one embodiment; and

FIG. 21 shows a crawler following insertion through a hot tap, according to one embodiment.

### DETAILED DESCRIPTION

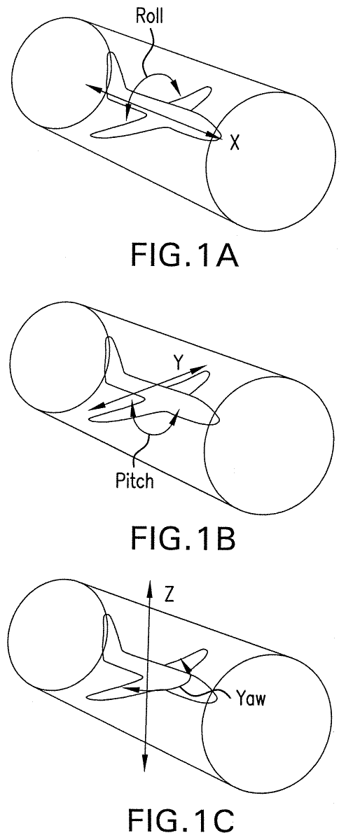

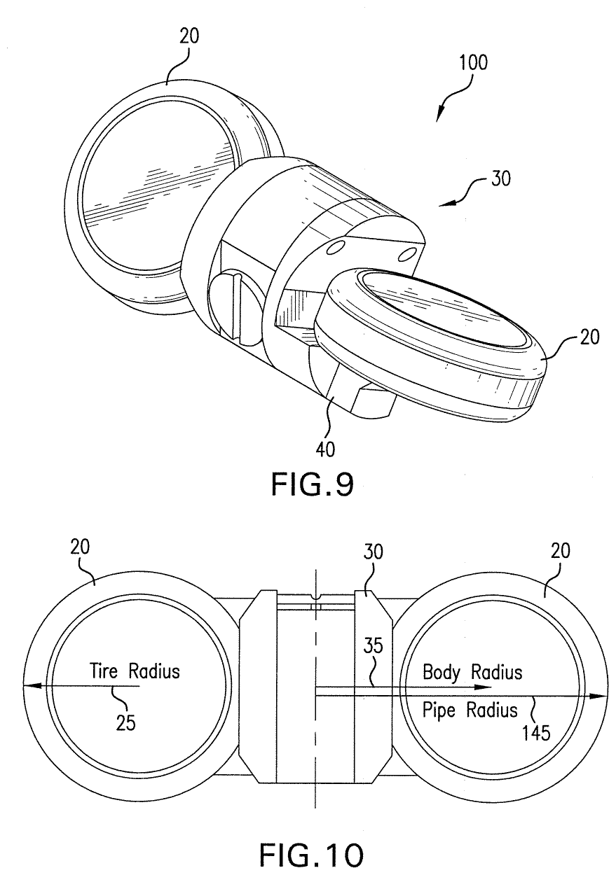

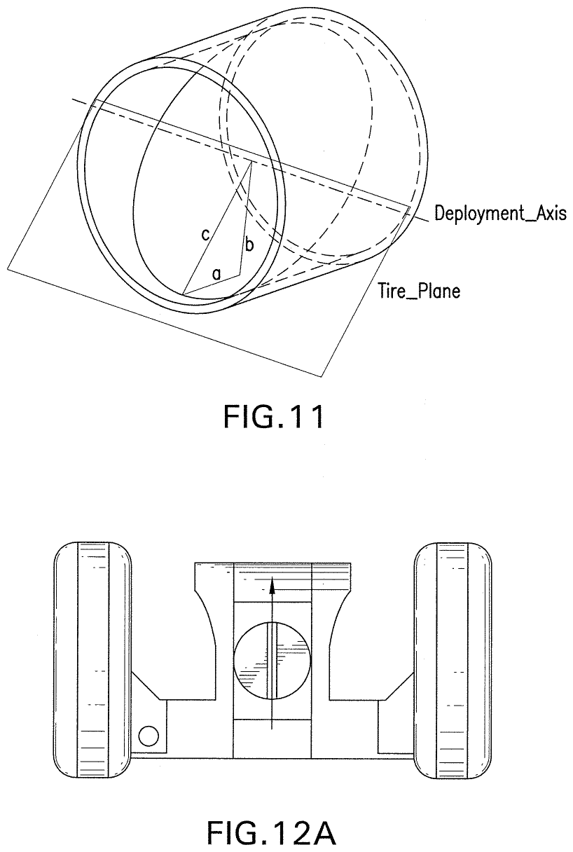

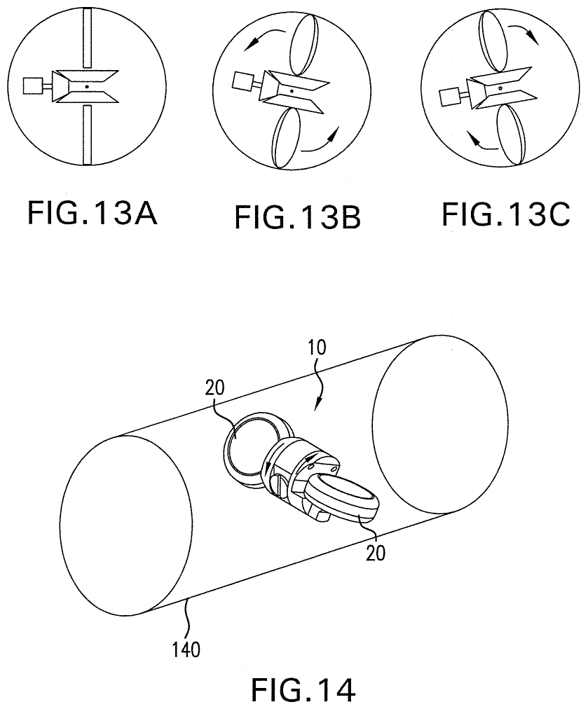

According to a preferred embodiment of the subject invention, a two-wheeled pipe crawler is disclosed which permits long-term flexible use within a pipeline with minimal maintenance and maximum mobility within a range of pipe sizes and configurations. The crawler disclosed herein, known as Gas Technology Institute's PIPERIDER crawler, includes configurations disclosed in embodiments shown in FIGS. 1-21.

FIG. 1A-C show schematically roll, pitch, and yaw, respectively, which are common rotational axis names from the aviation industry. Roll describes rotational movement about the X axis (the direction of travel) and is shown in FIG. 1A. FIG. 1B shows pitch which is the rotational movement about the Y axis, perpendicular to and horizontally aligned relative the direction of travel. FIG. 1C shows yaw which is the rotational movement about the Z axis, perpendicular to and vertically aligned relative to the direction of travel. Although “horizontal” and “vertical” are generally used herein, these terms are relative and depend on the relative orientation of the crawler 10. The axes are intended to be local and moveable depending on orientation.

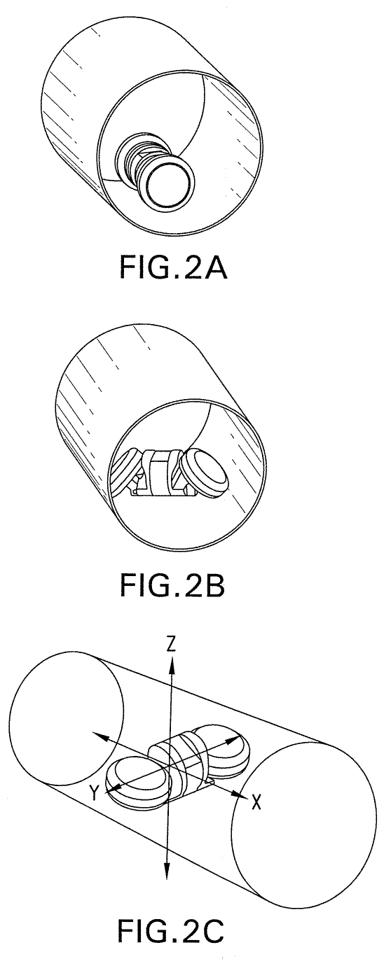

FIGS. 2A-C show schematically a crawler 10 of the subject invention, as further described below, transitioning between a retracted position in FIG. 2A, an intermediate position in FIG. 2B and a deployed position in FIG. 2C. The crawler 10 according to this invention is likewise capable of roll, pitch, and yaw controls as further described.

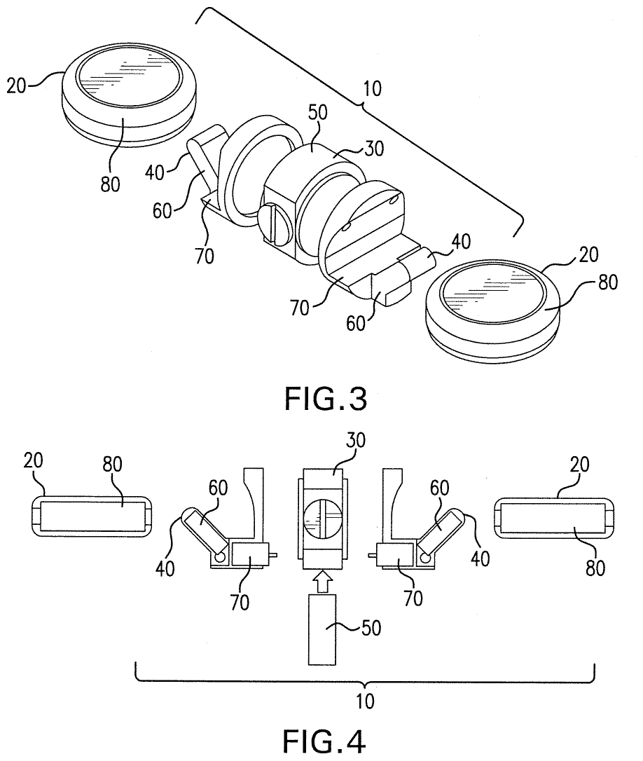

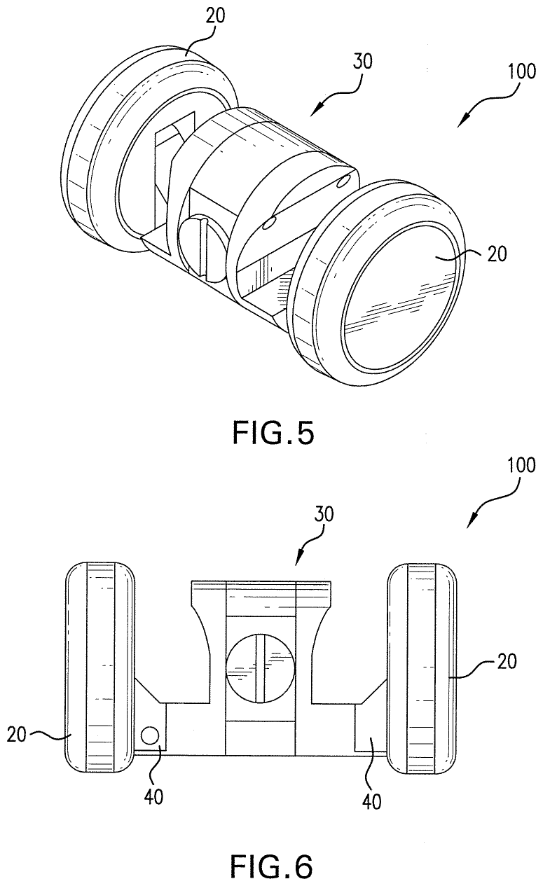

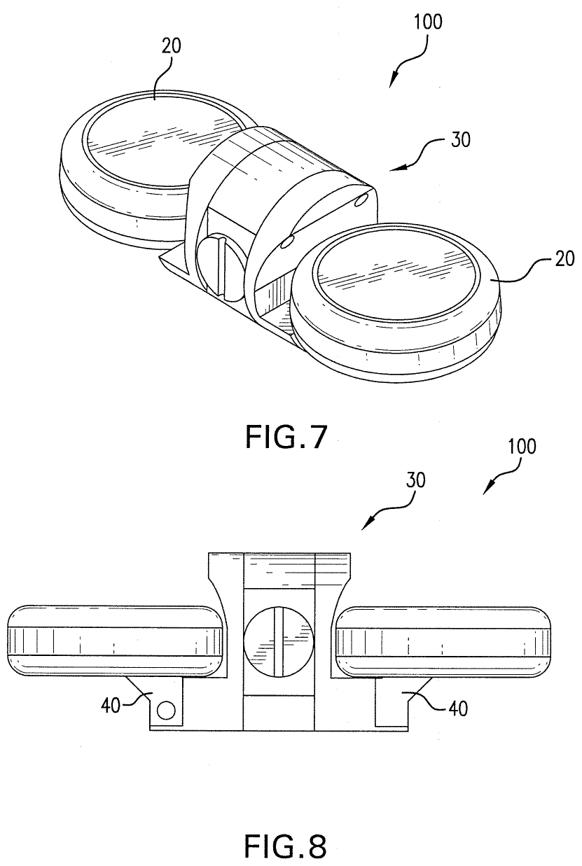

FIGS. 3-8 show some basic views of the crawler 10, in preferred embodiments of the subject invention, in exploded views at FIGS. 3 and 4, in the retracted position in FIGS. 5 and 6, and in the deployed position in FIGS. 7 and 8. The crawler 10 preferably includes two wheels 20, wherein one wheel 20 is positioned on each side of a body 30. The body 30 preferably further includes rotatable gimbals between the wheels 20 and the body 30 and one or more motors 50, 60, 70, 80, described in more detail below.

As best shown in FIGS. 5 and 6, the wheels 20 are preferably upright relative to the body 30 in a retracted position. The crawler 10 in the retracted position preferably includes wheels 20 that are parallel with respect to each other. Although not optimized for travel in this position, the crawler 10 is capable of maneuvering and movement while in this retracted position.

As best shown in FIGS. 7 and 8, the wheels preferably extend outwardly in a deployed position. In the deployed position, the wheels 20 are preferably aligned in a single plane for travel in a straight direction. Internal motors 60 described in more detail below may be used to move the wheels 20 between the retracted position and the deployed position. The crawler 10 is preferably moveably operable in both the retracted and deployed positions of the wheels 20, however, in the deployed position, movement and maneuverability is optimized.

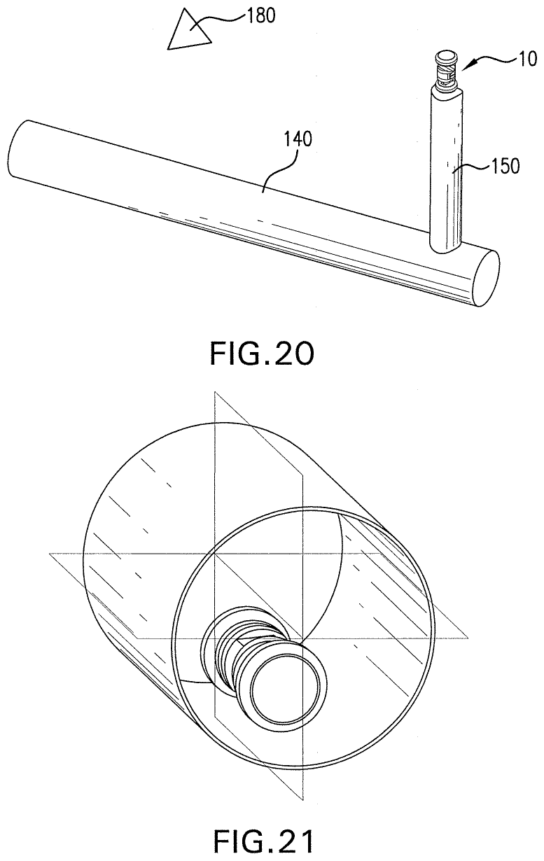

In the retracted position, the wheels 20 are parallel with respect to each other forming a more compact unit which may assist in inserting the crawler 10 into a pipeline, such as a pipe entry via a hot tap 150 as shown in FIGS. 20 and 21. Traditionally, existing crawlers require placement into a pipeline through a riser pipe because of their size. However, the crawler 10 according to subject invention may alternatively be placed into smaller and more convenient hot taps 150. As such, the crawler 10 includes body 30 and wheels 20 that are dimensioned to fit within a keyhole of a hot tap 150 when in the retracted position. The crawler 10 is configured to safely land on the bottom of a gas pipeline through the hot tap 150. Once inserted into a pipeline in the retracted position, the crawler 10 may then be placed into the deployed position for operation.

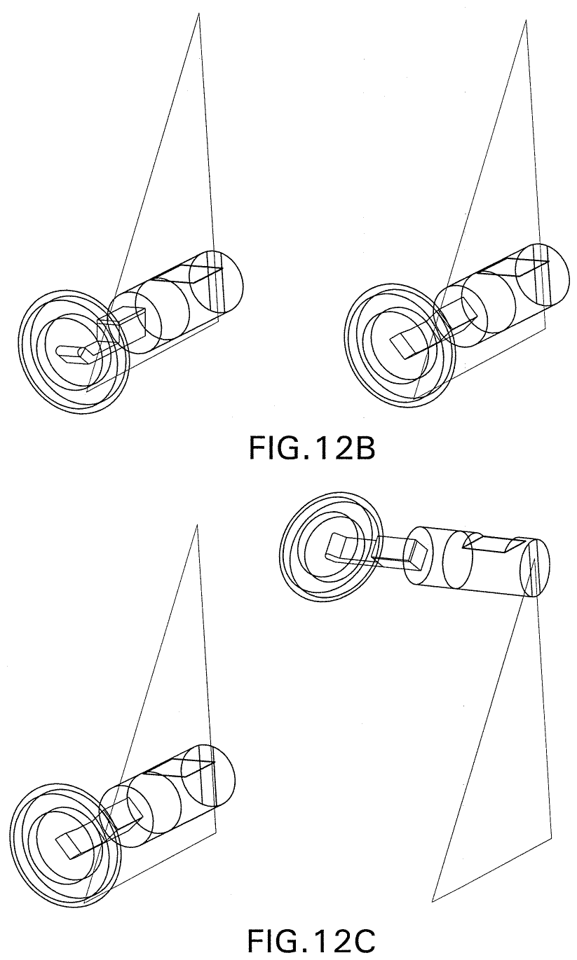

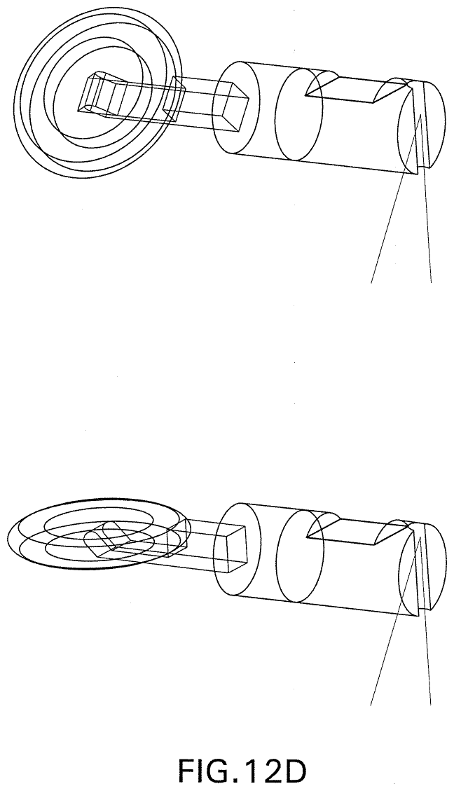

The crawler 10 may be deployed by driving tires in opposite directions while unfolding them and, once deployed, the crawler 10 may move axially through the pipeline such as shown in FIG. 12C. In such axial motion, the crawler 10 is preferably elevated off the bottom of the pipeline. In this manner, the crawler 10 can avoid detritus that may be present along a bottom surface of the pipeline.

Sizing of the crawler 10 may be accomplished with the following calculations as indicated in FIG. 10. Using SI units, a tire radius 25 is subtracted from a pipe radius 145 (b) to determine a body radius 35 (a). The major axis of the bottom half of an elliptical tire path (c) can be determined with the Pythagorean theorem. Then the radian angle of the elliptical tire path is the arctan of the body radius 35 divided by the pipe radius 145:

For example, for a PipeRadius 145 of 125 mm (b) minus a TireRadius 25 of 22 mm=a BodyRadius 35 of 103 mm (a). The major axis of the ellipse (c) is square root (BodyRadius\hat{ }2+PipeRadius\hat{ }2)=162 mm. The plane of the ellipse is at an angle from vertical=arctan (BodyRadius/PipeRadius)=0.6892 radians. This is also 39.5 degrees.

As best shown in FIGS. 12A-D, in one embodiment of this crawler 10, while laying at the bottom of the pipeline 140 after entry from the hot tap 150 or riser pipe, deployment is a preferably a 4-step process: (1) orientation to an upright position with wheels 20 still retracted using only translation motors 80 such as shown in FIG. 12A; (2) pre-deployment of the wheel gimbals 40 using both translation motors 80 and roll motors 70 simultaneously to inclination angle of elliptical path while tire remains motionless, as described above, and shown in FIG. 12B; (3) deployment using both translation motors 80 and deploy-retract motors 60 simultaneously while unfolding the wheels 20, as shown in FIG. 12C; and (4) post-deploy to return both wheels to a common plane as shown in FIG. 12D and FIG. 8 using roll motor 70 only to return wheel 20 from the inclination angle to the x-y plane. Specifically, deployment preferably involves simultaneously rotating the wheels 20 in opposite directions to climb a sidewall of the pipeline and then unfolding the wheels 20 to a coplanar orientation.

According to one embodiment, the body 30 may include a partitioned center section that is expandable or contractable using a spring or a rack. In this manner, the crawler 10 may include an onboard coarse adjustment to adapt the crawler 10 for different pipe sizes. Alternatively, the wheels 20 and/or gimbals 40 may be sized according to the calculations above to adapt to a particular pipe diameter. Based on the operation as described herein, however, the crawler 10 may function within a reasonable range of pipe sizes based on the dynamics of the crawler 10 in the deployed position.

In a preferred embodiment of the invention, the plant dynamics of the pipe crawler 10 are modeled as two mobile inverted pendulums. Using this model, a multi-axis control unit 100 is positioned within the body 30 of the crawler 10 to control a roll, pitch, and yaw within the pipeline.

According to a preferred embodiment, the multi-axis control unit 100 is capable of controlling not only roll and yaw but pitch of the crawler 10, as well. In this way, the crawler 10 is capable of movement around hard corners such as shown in FIG. 16A and 16B. Ideally, the crawler 10 as described can move horizontally or vertically through the pipeline.

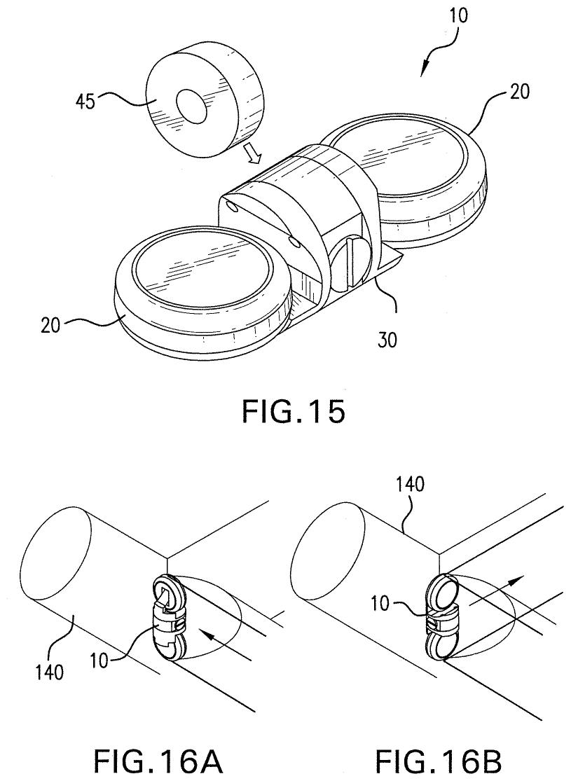

In order to affect such pitch control, the crawler 10 may further include a spinning mass located within the body 30 of the crawler 10, as shown in FIG. 15. More specifically, this spinning mass may comprise an internal flywheel 45. The internal flywheel 45 or similar spinning mass preferably spins on an axis perpendicular to a rotational axis of the wheels to control the pitch of the crawler 10. The multi-axis control unit 100 is preferably adapted to adjust a speed of the flywheel 45 within the body of the crawler 10 to control pitch thereby allowing the crawler 10 to turn a corner.

Per the aviation terminology described above, pitch is rotation about the y axis. The equation is from Kinetics Impulse-Momentum and is known as the Conservation of Angular Momentum equals Mass Moment of Inertia times the Angular Velocity of the spinning mass. When the spinning flywheel 45 is stopped by the control unit 100, momentum of the flywheel 45 is transferred to the crawler body 30, thus changing the pitch of the crawler 10.

As described above, the crawler 10 preferably includes one or more motors to provide the intended motion and maneuverability. In one preferred embodiment, the crawler includes seven motors on or within the body. A pitch motor 50 is preferably positioned within the body 30 to activate, operate and maintain the flywheel 45 or similar spinning mass or reaction wheel.

A deploy-retract motor 60 is preferably positioned with respect to each wheel 20 and gimbal 40 such as shown schematically in FIGS. 3 and 4. Likewise, a roll motor 70 is preferably positioned with respect to each wheel 20 to adjust the angle of the tire gimbals 40. In addition, a translation motor 80 is preferably positioned with respect to each wheel 20 as shown in FIGS. 3 and 4 to impart forward and reverse motion to the wheels 20.

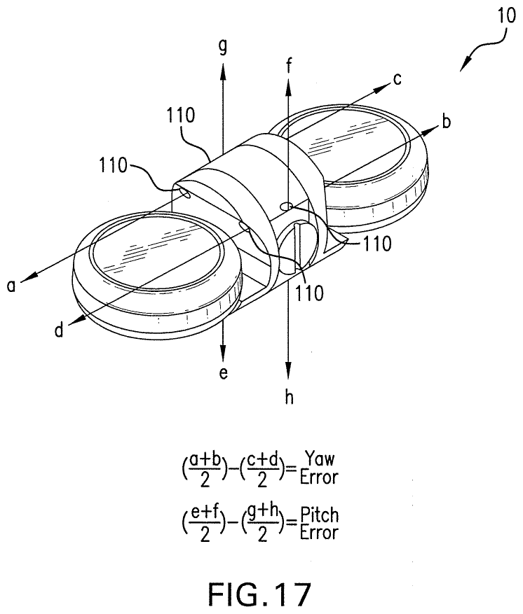

To facilitate control of the crawler, particularly pitch and yaw control, the multi-axis control unit 100 preferably receives distance measurement data from one or more onboard sensors 110 to control yaw and pitch of the crawler 10 within the pipeline. FIG. 17 demonstrates one embodiment of such distance measurements. Preferably these measurements are taken and processed in real time to constantly adjust and maintain control of the crawler 10 as it proceeds through a pipeline. As shown in FIG. 17, at least two measurements are preferably taken in each of the vertical (Z) for yaw and horizontal (Y) for pitch in order to maintain and correct the movement of the crawler 10.

Using FIG. 17 as an illustration, on each respective yaw or pitch plane, the difference of the average of two opposing sensors results in the error used by the control unit 100 in real time to align a centerline of the crawler 10 with a centerline of the pipe. In fact, such measurements and feedback preferably occur many times per second to maintain the course and travel of the crawler 10.

The multi-axis control unit 100 preferably comprises a closed loop position control algorithm to allow the 4 degrees of freedom motion. A high-speed processor further enables the feedback loop necessary to maintain the crawler 10.

As described above, the distance sensors 110 are preferably located in at least the vertical and horizontal direction and preferably include two such sensors 110 in each direction. Preferable sensors 110 may include structured light cameras or LIDAR positioned with respect to the body. The multi-axis control unit 100 is preferably configured to adjust the speed of each wheel 20 independently based on feedback from the one or more sensors 110 for yaw control as the crawler 10 proceeds through the pipeline.

As shown in FIGS. 16A and 16B, the pitch angle of the crawler 10 may be controlled so it can turn a corner (pitch control). As shown, one or more onboard sensors 110 may detect that no sidewall is present at a junction of the pipeline and the crawler 10 may then back-up and realign vertically as shown in FIG. 16A before turning the corner as shown in FIG. 16B. The crawler may then realign again to a horizontal configuration to move axially as shown in the top views of FIGS. 17-19.

FIG. 19 shows the crawler 10 in a deployed position relative to the walls of a gas pipeline (yaw control). The arrows represent distance measurements preferably taken in realtime by the onboard sensors 110 of the crawler. In one embodiment, four sensors 110 are positioned on the body 30 such that a fore and aft sensor 110 are positioned on each transverse side of the body 30. In this way, measurements to the sidewall are compared on each side of the body 30 and when the measurements are equal on each side of the crawler, equilibrium and thus yaw control is obtained within the pipeline. As described, sensors 110 may be four distance sensors as described above or may include any one or more single sensor or array of sensors capable of measuring distance to the sidewall of the pipe. Such sensors may include camera-based sensors, structured light sensors, laser measurement devices, LIDAR, infrared light, ultrasonic sound distance sensors, and LIDAR time of flight sensors, photoelectric sensors or any other suitable device for fast and accurate measurement of a distance between a position on or near the body 30 and the pipe sidewall.

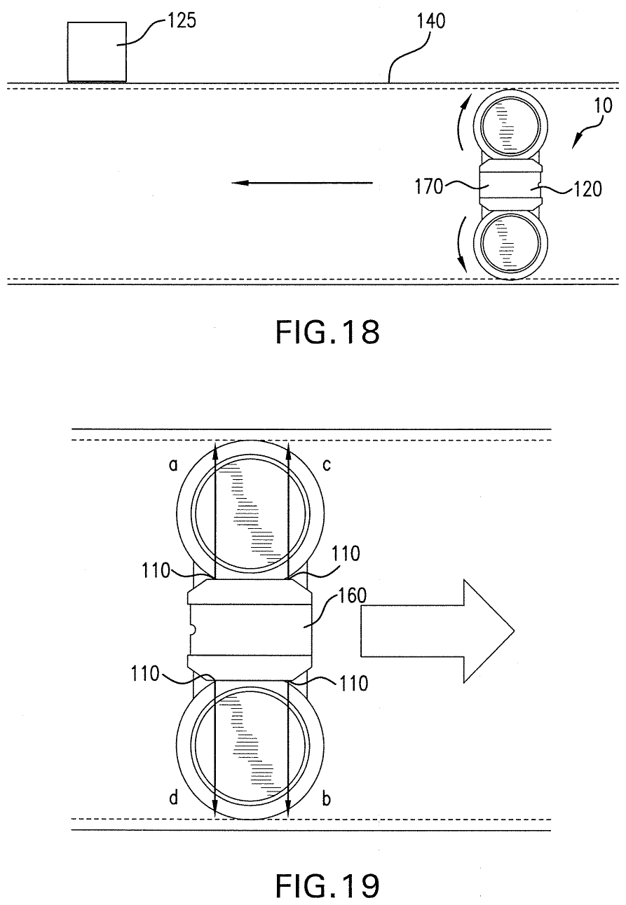

The crawler 10 may further include a rechargeable battery 120, such as shown schematically in FIG. 18. The rechargeable battery 120 may be nickel-cadmium (NiCd), nickel-metal hydride (NiMH), lithium-ion (Li-ion), Lithium Iron Phosphate (LiFePO4), lithium-ion polymer (Li-ion polymer), or other suitable compact battery composition capable of long battery life and short recharging durations. The rechargeable battery 120 may be chargeable using inductive charging and the pipeline may include one or more inductive charging stations 125, also shown schematically in FIG. 18. In this manner, the crawler 10 may be recharged without any contact between the crawler 10 and the charging station 125 which is ideal in a pipeline environment. A virtual infinite range may be provided to the crawler 10 through a series of such charging stations 125. This allows the crawler 10 to be established semi-permanently within a given pipeline by including a means or system for recharging onboard batteries.

Alternatively, the crawler 10 and/or rechargeable battery 120 may be charged or powered using an internal generator for generating electrical power from a gas flowing within the pipeline. A turbine or similar generator may be positioned on the crawler 10 to generate a charge from the flow of gas within the pipeline, such as natural gas. In this way, energy may be harvested from inside a live natural gas pipeline to charge the battery.

The crawler 10 may further include a camera 160, such as shown in schematically in FIG. 19. The camera 160 may operate as a sensor 110 described above or may be alternatively or additionally positioned to accommodate visual inspection of the pipeline.

A corresponding method of operation of an untethered crawler 10 for use within a pipeline includes: providing the crawler 10 having a body 30 and pair of wheels 20 that are positionable between a retracted and a deployed position; positioning the wheels 20 in the retracted position and inserting the crawler 10 into a pipeline; moving the wheels 20 into the deployed position, preferably along gimbals 40; and controlling the yaw, roll, and pitch of the crawler using a multi-axis control unit. The crawler 10 as described is preferably operable in both the retracted and the deployed position.

As partially described above, the crawler is preferably capable of one or more work functions that were previously unavailable for remote devices. To accomplish one or more of these tasks, an additional payload 170 may be necessary for placement on or within the crawler. The payload 170 is shown schematically in FIG. 18. Such payload 170 may be integrated with the body 30 or may be positioned on the body 30 or the wheels 20 depending on the desired functionality.

One object of the crawler 10 as described is to transport interchangeable inspection and repair payloads. Such payloads may include locational and/or mapping devices, repair devices, inspection devices and/or other similar payloads which may be required in a pipeline environment.

In environments where a wireless signal may be difficult to obtain or maintain within a pipeline, a surface slave vehicle 180 may be used to “chase” the crawler from above ground or outside of the pipeline and to relay signals to and/or from the crawler, such as shown schematically in FIG. 20. The slave vehicle 180 may comprise an aerial drone, an autonomous vehicle or even a human operator following a signal transmitted to the surface.

According to one embodiment, the payload 170 may comprise a microphone array positioned relative to the crawler to triangulate and orient around a gas leak such that an epoxy syringe or similar repair device can repair a gas leak from inside a pipe. As such, an additional payload 170 may include an epoxy gun or similar repair device for urging a curable composition into a leak in the pipeline.

According to another embodiment, an inertial measurement unit may be used on the crawler to record location data of a pipeline. Such location data may be assembled to generate a highly accurate map of the entire pipeline system. Alternatively, or in addition, the crawler 10 may include a tire encoder in communication with the multi-axis control unit 100 to obtain data for mapping pipelines.

If necessary, the crawler 10 may be removed entirely from the pipeline through a magnetic retrieval tether. The wheels 20 may be retracted or partially retracted in order to facilitate removal from a removal station, a hot tap or any other similar station for removing the crawler 10.

While in the foregoing detailed description the subject development has been described in relation to certain preferred embodiments thereof, and many details have been set forth for purposes of illustration, it will be apparent to those skilled in the art that the subject development is susceptible to additional embodiments and that certain of the details described herein can be varied considerably without departing from the basic principles of the invention.

We claim:

1. An untethered crawler for use within a pipeline, the crawler comprising:
a body;
a pair of wheels that are positionable between a retracted and a deployed position; and
a multi-axis control unit for controlling a roll, pitch, and yaw of the crawler within the pipeline.

2. The crawler of claim 1 wherein in the deployed position, the wheels are aligned in a single plane for travel in a straight direction.

3. The crawler of claim 2 wherein in the retracted position, the wheels are parallel with respect to each other.

4. The crawler of claim 1 further comprising a spinning mass located within the body of the crawler.

5. The crawler of claim 4 wherein the spinning mass comprises an internal flywheel.

6. The crawler of claim 4 wherein the spinning mass spins on an axis perpendicular to a rotational axis of the wheels to control the pitch of the crawler.

7. The crawler of claim 1 wherein the multi-axis control unit adjusts a speed of a flywheel within the body of the crawler to control pitch thereby allowing the crawler to turn a corner.

8. The crawler of claim 1 wherein the multi-axis control unit receives distance measurement data from one or more onboard sensors to control yaw and pitch of the crawler within the pipeline.

9. The crawler of claim 1 wherein the crawler is moveably operable in both the retracted and deployed positions of the wheels.

10. The crawler of claim 1 further comprising:
a pitch motor within the body;
a deploy-retract motor positioned with respect to each wheel;
a roll motor positioned with respect to each wheel; and
a translation motor positioned with respect to each wheel.

11. The crawler of claim 1 wherein the body and the wheels are dimensioned to fit within a keyhole when in the retracted position.

12. The crawler of claim 1 further comprising a rechargeable battery.

13. The crawler of claim 12 wherein the rechargeable battery is chargeable using inductive charging and wherein the pipeline includes one or more inductive charging stations.

14. The crawler of claim 1 wherein the multi-axis control unit comprises a closed loop position control algorithm for 4 degrees of freedom motion.

15. The crawler of claim 1 further comprising at least one or more distance sensors, structured light cameras, infrared light, ultrasonic sound distance sensors, and LIDAR positioned with respect to the body.

16. The crawler of claim 1 further comprising a camera.

17. The crawler of claim 1 further comprising an internal generator for generating electrical power from a gas flowing within the pipeline.

18. The crawler of claim 1 wherein the crawler is configured to move horizontally or vertically within the pipeline.

19. The crawler of claim 1 wherein the multi-axis control unit is configured to adjust the speed of each wheel independently for yaw control as the crawler proceeds through the pipeline.

20. The crawler of claim 1 further comprising a tire encoder in communication with the multi-axis control unit to obtain data for mapping pipelines.

21. The crawler of claim 1 further comprising an aerial drone paired with the crawler to relay mapping or leak location data to a server.

22. A method of operation of an untethered crawler for use within a pipeline, the method comprising:
providing crawler having a body and pair of wheels that are positionable between a retracted and a deployed position;
positioning the wheels in the retracted position and inserting the crawler into a pipeline;
moving the wheels into the deployed position;
controlling a yaw, roll, and pitch of the crawler using a multi-axis control unit.

23. The method of claim 22 wherein the wheels are operable in both the retracted and the deployed position.

24. The method of claim 22 further comprising a spinning mass within the body to control the pitch of the crawler.

25. The method of claim 22 further comprising dropping the crawler through a keyhole of a pipeline in the retracted position.

26. The method of claim 22 further comprising repairing a damaged section of the pipeline using a payload on the crawler.

27. The method of claim 22 further comprising moving the crawler around corners of the pipeline by controlling the pitch of the crawler.

28. The method of claim 22 further comprising viewing an inside of the pipeline using a camera positioned on the crawler.

29. The method of claim 22 further comprising deploying the wheels by simultaneously rotating the wheels in opposite directions to climb a sidewall of the pipeline and unfolding the wheels to a coplanar orientation.

30. The method of claim 22 further comprising charging a rechargeable battery within the crawler using inductive charging from one or more inductive charging stations located with respect to the pipeline.

31. The method of claim 22 further comprising obtaining data from a tire encoder to generate pipeline maps.

32. The method of claim 22 further comprising pairing an aerial drone with the crawler to relay data from the crawler to a remote or onboard server.

33. The crawler of claim 1 further comprising a payload.

34. The crawler of claim 33 wherein the payload comprises a microphone array.

35. The crawler of claim 34 wherein the microphone array is configured to detect a leak in the pipeline.

36. The crawler of claim 33 wherein the payload comprises a repair module.

37. The crawler of claim 36 wherein the repair module comprises an epoxy gun for repairing damaged pipelines.
